(19) United States
(12) Patent Application Publication
(10) Pub. No.: US 2022/0092572 A1
(43) Pub. Date: Mar. 24, 2022

(54) PURCHASE SUPPORT APPARATUS, PURCHASE SUPPORT METHOD, AND PROGRAM

(71) Applicant: TOSHIBA TEC KABUSHIKI KAISHA, Tokyo (JP)

(72) Inventor: Nagisa OONO, Mishima (JP)

(73) Assignee: TOSHIBA TEC KABUSHIKI KAISHA, Tokyo (JP)

(21) Appl. No.: 17/337,988

(22) Filed: Jun. 3, 2021

(30) Foreign Application Priority Data
Sep. 23, 2020 (JP) 2020-159054

(51) Int. Cl. G06Q 20/20; G06Q 30/02; G07G 1/00

(52) U.S. Cl. CPC G06Q 20/206; G06Q 30/0238; G06Q 20/204; G07G 1/0009; G07G 1/0018

(57) ABSTRACT

A purchase support apparatus includes a registering unit, a detecting unit, and an output unit. The registering unit registers information indicating acquisition of a privilege code. The detecting unit detects a payment instruction. The output unit outputs a different notification according to presence or absence of the registration of the information indicating the acquisition.

### CROSS-REFERENCE TO RELATED APPLICATION

This application is based upon and claims the benefit of priority from Japanese Patent Application No. 2020-159054, filed on Sep. 23, 2020, the entire contents of which are incorporated herein by reference.

### FIELD

Embodiments described herein relate generally to a purchase support apparatus, a purchase support method, and a program.

### BACKGROUND

In a purchase support apparatus such as a POS (Point Of Sales) terminal or an electronic cash register, usually, a store clerk called cashier is in charge of operation and applies privilege information of a coupon, a discount ticket, or the like.

A purchase support apparatus of a self-service checkout system is known, a so-called self-service checkout apparatus with which a customer performs operation from registration to settlement of purchased commodities by himself or herself. Since the customer himself or herself operates the self-service checkout apparatus, a person in charge of operation is absent. Accordingly, the customer calls a store clerk every time the customer reads a coupon, a discount ticket, or the like in the self-service checkout apparatus. This imposes a burden on a store.

### DESCRIPTION OF THE DRAWINGS

FIG. 1 is a block diagram illustrating a schematic configuration of a self-service checkout system according to at least one embodiment;

FIG. 2 is an exterior perspective view of a self-service POS terminal incorporated in the self-service checkout system;

FIG. 3 is a block diagram of the self-service POS terminal;

FIG. 4 is a diagram illustrating an example of a commodity registration screen displayed on a touch panel of the self-service POS terminal;

FIG. 5 is a diagram illustrating an example of a screen for selecting presence or absence of a privilege use displayed on the touch panel;

FIG. 6 is a diagram illustrating an example of a store clerk call screen displayed on the touch panel;

FIG. 7 is a diagram illustrating an example of a screen showing presence of the privilege use displayed on the touch panel;

FIG. 8 is a diagram illustrating an example of a mode selection screen displayed on the touch panel;

FIG. 9 is a diagram illustrating an example of a settlement screen displayed on the touch panel; and

FIG. 10 is a flowchart illustrating a procedure of purchase support processing by the self-service POS terminal.

### DETAILED DESCRIPTION

An object of at least one embodiment is to reduce a burden on a store in order to solve the problem described above.

A purchase support apparatus according to at least one embodiment includes a registering unit (of at least one processor), a detecting unit (e.g., a detector of at least one processor), and an output unit (of at least one processor). The registering unit registers information indicating acquisition of a privilege code. The detecting unit detects a payment instruction. The output unit outputs a different notification according to presence or absence of the registration of the information indicating the acquisition.

At least one embodiment is explained below with reference to the drawings. In this at least one embodiment, a self-service POS terminal is illustrated as a form of a purchase support apparatus. The self-service POS terminal functions as a purchase support apparatus of a self-service checkout system, a so-called self-service checkout apparatus with which a customer performs operation from registration to settlement of purchased commodities by himself or herself.

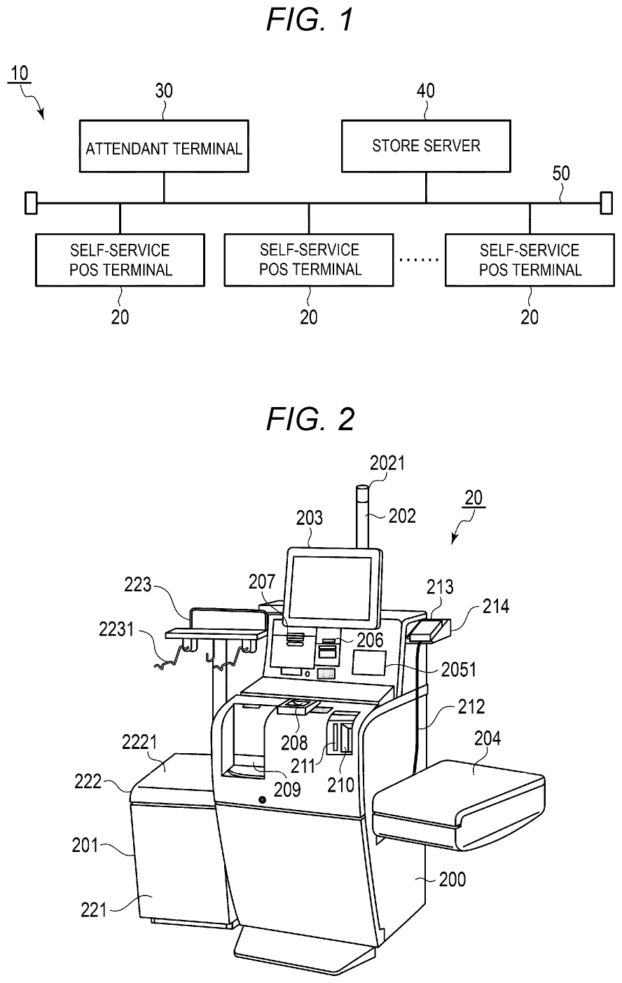

FIG. 1 is a block diagram illustrating a schematic configuration of a self-service checkout system according to the embodiment.

A self-service checkout system 10 includes a plurality of self-service POS terminals 20, an attendant terminal 30, and a store server 40. The self-service checkout system 10 includes a network 50. The self-service POS terminals 20, the attendant terminal 30, and the store server 40 are connected to the network 50 to construct a system. The network 50 is typically a LAN (Local Area Network). The LAN may be a wired LAN or may be a wireless LAN.

The self-service POS terminal 20 is set in a payment place of a store. The self-service POS terminal 20 is a purchase support apparatus that enables a customer, who purchases commodities, to perform a series of processing from registration to settlement of the purchased commodities by himself or herself. Accordingly, in the self-service POS terminal 20, an operation guide indicating an operation procedure is displayed to the customer, who is an operator. Details of the self-service POS terminal 20 are explained below.

The attendant terminal 30 is set, for example, near an exit of the payment place. The attendant terminal 30 has a function of monitoring states of the plurality of self-service POS terminals 20. That is, the attendant terminal 30 receives, via the network 50, various kinds of information, for example, information indicating an operation state, a processing result of commodity sales information, and the like transmitted and output by a monitoring target self-service POS terminal 20, and displays content of the information on a display. The commodity sales information includes, for example, a commodity ID, a unit price, the number of sold items, and a sales amount of a purchased commodity registered by the customer via the self-service POS terminal 20.

The number of the self-service POS terminals 20 monitored by one attendant terminal 30 is optional. Accordingly, although only one attendant terminal 30 is illustrated in FIG. 1, two or more attendant terminals 30 may be connected to the network 50. Usually, a store clerk working as an attendant stays on standby in a place where the attendant terminal 30 is set. The store clerk copes with, according to display content on the display, troubleshooting such as dealing with an error that occurs in the monitoring target self-service POS terminal 20.

The store server 40 controls processing relating to registration and settlement of purchased commodities executed in the self-service POS terminals 20. The store server 40 collects, via the network 50, data processed by the self-service POS terminals 20, processes the data as appropriate, and saves the data in a data file.

In FIG. 1, only the self-service POS terminals 20 are illustrated as purchase support apparatuses connected to the network 50. However, purchase support apparatuses, so-called POS terminals with which store clerks perform operation from registration to settlement of purchased commodities may be connected to the network 50. In that case, the store server controls the POS terminals like the self-service POS terminals 20.

Details of the self-service POS terminal 20 are explained.

FIG. 2 is an exterior perspective view of the self-service POS terminal included in the self-service checkout system according to at least one embodiment.

As illustrated in FIG. 2, the self-service POS terminal 20 includes a main body 200 set on a floor surface and a scale unit 201 set beside the main body 200.

A display pole 202 and a touch panel 203 are attached to upper parts of the main body 200. A basket table 204 is projected to the opposite side of a side where the scale unit 201 is set. The basket table 204 is a table on which a customer places a basket or the like including purchased commodities. The customer performs work standing on the near side of the main body 200 in FIG. 2 to be able to see a screen of the touch panel 203. Accordingly, when viewed from the customer, the basket table 204 is present on the right side of the main body 200 and the scale unit 201 is present on the left side of the main body 200. In the following explanation, the side where the customer stands is represented as front of the maim body 200.

The display pole 202 includes, at the distal end portion thereof, a light emitting unit 2021 that selectively emits, for example, light in blue and red. The display pole 202 informs, with the light emission color, a present state of the self-service POS terminal 20 to, for example, the store clerk, who is the attendant.

The touch panel 203 is configured by a display for displaying various screens including an operation guide to an operator (usually the customer) of the self-service POS terminal 20 and a touch sensor for detecting a touch input to the screens by the operator. The screens mean images displayed on the display. A display method for the screens may be any method including popup display. The display of the touch panel 203 is an example of the display unit. The touch sensor of the touch panel 203 is an example of the input unit.

In the main body 200, a reading window 2051 of a scanner 205, a card insertion port 206, and a receipt dispensing port 207 are formed in an upper part of the front. In the main body 200, a coin depositing port 208, a coin dispensing port 209, a bill insertion port 210, and a bill dispensing port 211 are formed in the center of the front. Further, a reader writer (I/O device) 213 for electronic money is connected to the main body 200 via a communication cable 212. The reader writer 213 is placed on a placing table 214 provided on the same side as the basket table 204 of the main body 200.

The scale unit 201 has structure in which a scale pan 222 is provided in an upper part of a housing 221 and a bag holder 223 is attached above the scale pan 222. The upper surface of the scale pan 222 is a placement surface 2221. The bag holder 223 includes a pair of holding arms 2231. A register bag or a shopping bag, sometimes referred to as “my bag”, carried by the customer is held by the holding arms 2231.

The scale unit 201 measures the weight of commodities put in the register bag or the “my bag” held by the holding arms 2231 and placed on the placement surface 2221.

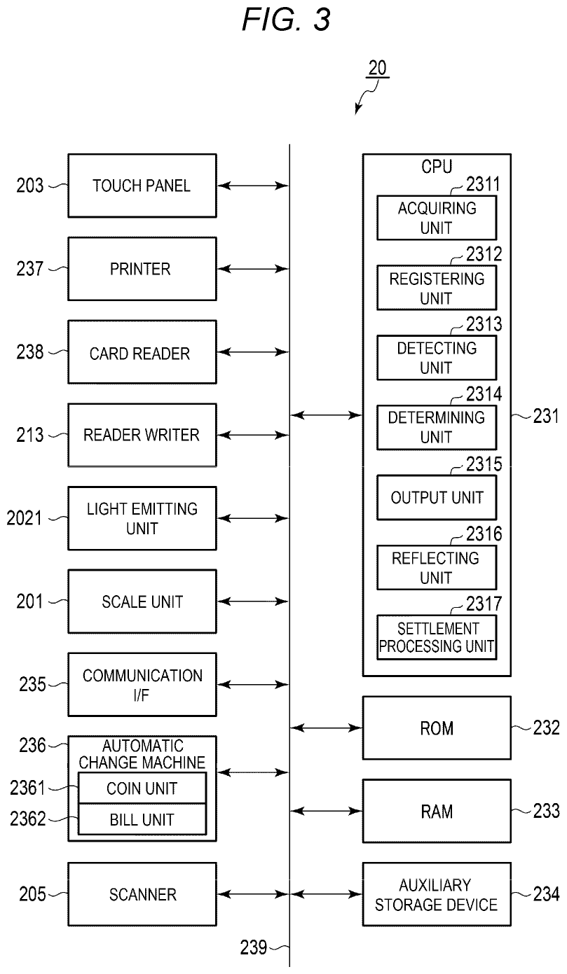

FIG. 3 is a block diagram of the self-service POS terminal 20 according to the embodiment.

As illustrated in FIG. 3, the self-service POS terminal 20 includes a CPU (Central Processing Unit) 231, which may include one or more processors, a ROM (Read Only Memory) 232, a RAM (Random Access Memory) 233, an auxiliary storage device 234, a communication interface 235, an automatic change machine 236, the scanner 205, the touch panel 203, a printer 237, a card reader 238, the reader writer 213, the light emitting unit 2021, the scale unit 201, and a system transmission line 239. The system transmission line 239 includes an address bus, a data bus, and a control signal line. The system transmission line 239 connects the CPU 231 and the other units directly or via a signal input and output circuit and transmits a data signal exchanged between the CPU 231 and the other units.

In the self-service POS terminal 20, the CPU 231, the ROM 232, the RAM 233, and the auxiliary storage device 234 are connected by the system transmission line 239 to configure a computer.

The CPU 231 is equivalent to a central part of the computer. The CPU 231 controls the units according to an operating system and application programs in order to realize various functions of the self-service POS terminal 20. The CPU 231 may be configured by various circuits such as by at least one processor. The CPU 231 loads, in the RAM 233, a control program stored in advance in the ROM 232 or the auxiliary storage device 234. The control program is a program for causing the CPU 231 of the self-service POS terminal 20 to realize units explained below. The CPU 231 executes the control program loaded in the RAM 233 to execute various operations.

The ROM 232 is equivalent to a main storage part of the computer. The ROM 232 stores the operating system and the application programs. The application programs include the control program. The ROM 232 sometimes stores data necessary for the CPU 231 in executing processing for controlling the units.

The RAM 233 is equivalent to the main storage part of the computer. The RAM 233 stores data necessary for the CPU 231 in executing processing. The RAM 233 is also used as a work area where information is rewritten as appropriate by the CPU 231.

The auxiliary storage device 234 is equivalent to an auxiliary storage part of the computer. For example, a HDD (Hard Disc Drive), an SSD (Solid State Drive), or an EEPROM (registered trademark) (Electric Erasable Programmable Read-Only Memory) is used as the auxiliary storage device 234. The auxiliary storage device 234 saves data used by the CPU 231 in performing various kinds of processing and data generated by the processing in the CPU 231. The auxiliary storage device 234 sometimes stores the control program.

The communication interface 235 performs data communication with the store server 40 or the attendant terminal 30 connected to the network 50 according to a preset communication protocol. In FIG. 3, an interface is described as “I/F”.

The automatic change machine 236 includes a coin unit 2361 and a bill unit 2362.

The coin unit 2361 sorts, one by one, coins deposited to the coin depositing port 208, identifies denominations of the coins, and stores the coins in a coin safe (not illustrated) for each of the denominations. The coin unit 2361 takes out, for example, based on change data, coins of denominations corresponding to the change data from the coin safe and dispenses the coins to the coin dispensing port 209.

The bill unit 2362 sorts, one by one, bills inserted into the bill insertion port 210, identifies denominations of the bills, and stores the bills in a bill safe (not illustrated) for each of the denominations. The bill unit 2362 takes out, for example, based on change data, bills of denominations corresponding to the change data from the bill safe and dispenses the bills to the bill dispensing port 211.

The scanner 205 scans and reads a barcode of a commodity held over the reading window 2051. Barcode symbols obtained by converting commodity IDs for identifying commodities sold in the store into barcodes are attached to the commodities. Every time a barcode symbol attached to a commodity is held over the reading window 2051, the scanner 205 reads the barcode. The scanner 205 scans and reads a privilege barcode attached to a coupon, a discount ticket, or the like held over the reading window 2051. The privilege barcode is explained as being a print attached to a medium of the coupon or the discount ticket but may be an image displayed on a terminal such as a smartphone. Barcode symbols obtained by converting privilege IDs for identifying privileges of coupons, discount tickets, and the like into barcodes are given to the privileges. The privilege barcodes are equivalent to privilege codes. The scanner 205 scans and reads a store clerk code held over the reading window 2051. Barcode symbols obtained by converting store clerk IDs for identifying store clerks into barcodes are given to the store clerks. The barcode may read a two-dimensional data code. The scanner 205 may be a type for reading a code symbol with scanning of laser light. The scanner 205 may be a type for reading a code symbol from an image captured by an imaging device such as a camera. The scanner 205 is an example of the reading unit.

The printer 237 prints, for example, receipt data representing details of a commercial transaction on receipt paper. The receipt paper, on which the receipt data is printed, is discharged from the receipt dispensing port 207, cut by a not-illustrated cutter, and dispensed as a receipt.

The card reader 238 reads card data recorded in a card medium such as a credit card or a point card. The card reader 238 draws the card medium, which is inserted into the card insertion port 206, into the main body 200 and, after reading the card data, discharges the card medium from the card insertion port 206.

The reader writer 213 reads and rewrites electronic money recorded in a noncontact IC card.

A hardware configuration of the self-service POS terminal 20 is not limited to the configuration explained above. The self-service POS terminal 20 enables omission and change of the components explained above and addition of new components as appropriate.

Units implemented in the CPU 231 are explained.

The CPU 231 is implemented with an acquiring unit 2311, a registering unit 2312, a detecting unit 2313, a determining unit 2314, an output unit 2315, a reflecting unit 2316, and a settlement processing unit 2317. The units implemented in the CPU 231 can also be considered functions. The units implemented in the CPU 231 can also be considered as being implemented in a control unit including the CPU 231, the ROM 232, and the RAM 233.

The acquiring unit 2311 acquires data of various codes. The various codes are explained as being read by the scanner 205 but may be input to the touch panel 203. In the following explanation, “read by the scanner 205” may read “read by the scanner 205 or input to the touch panel 203”. The acquiring unit 2311 acquires various kinds of information based on the acquired data. In an example, the acquiring unit 2311 acquires a store clerk code read by the scanner 205 and acquires store clerk information correlated with the store clerk code. The store clerk code being acquired by the acquiring unit 2311 corresponds to the store clerk code being read by the scanner 205. The acquisition of the store clerk code corresponds to reading of the store clerk code or input of the store clerk code. The store clerk information is various kinds of information correlated with the store clerk code and includes information such as validity of the store clerk code and a name of the store clerk. A database in which store clerk codes and store clerk information are correlated may be stored in advance in the auxiliary storage device 234 or may be downloaded to the self-service POS terminal 20 from the store server 40 or a not-illustrated server via the network 50. The database may be updated as appropriate.

In another example, the acquiring unit 2311 acquires a privilege code read by the scanner 205 and acquires privilege information correlated with the privilege code. The privilege code being acquired by the acquiring unit 2311 corresponds to the privilege code being read by the scanner 205. The acquisition of the privilege code corresponds to reading of the privilege code or input of the privilege code. The privilege information is various kinds of information correlated with the privilege code and includes information such as validity of the privilege code and content of a privilege. The privilege information may read privilege condition. A database in which privilege codes and privilege information are correlated may be stored in advance in the auxiliary storage device 234 or may be downloaded to the self-service POS terminal 20 from the store server 40 or the not-illustrated server via the network 50. The database may be updated as appropriate.

The registering unit 2312 registers various kinds of information based on data read by the scanner 205. In an example, if a barcode of a commodity is read by the scanner 205, the registering unit 2312 registers commodity sales information of the commodity. The commodity sales information is various kinds of information correlated with a commodity ID. The commodity sales information may be stored in advance in the auxiliary storage device 234 or may be downloaded to the self-service POS terminal 20 from the store server 40 or the not-illustrated server via the network 50. The database may be updated as appropriate.

In another example, if the acquiring unit 2311 acquires a privilege code read by the scanner 205, the registering unit 2312 registers information indicating the acquisition of the privilege code. The information indicating the acquisition of the privilege code is information indicating that the privilege code is acquired by the acquiring unit 2311. For example, the registering unit 2312 sets, in response to the privilege code being acquired by the acquiring unit 2311, a flag indicating presence or absence of the acquisition of the privilege code in the auxiliary storage device 234. For example, the flag is set to “1” if the privilege code is acquired and is set to “0” if the privilege code is not acquired. “1” corresponds to the information indicating the acquisition of the privilege code. The flag can also be set or reset by manual operation by the store clerk.

The detecting unit 2313 detects a touch input to the screen by the operator in the touch panel 203. The touch input is realized by the screen being touched by the operator according to various operation guides displayed on the touch panel 203. The screen on which the operation guides are displayed includes buttons for designating operation. The operator designates operation by touching a displayed button. The touch input is an example of an input including an input of a payment instruction, an input of confirmation, an input of yes and no, and an input of mode selection. The operation guides are equivalent to notifications.

For example, the detecting unit 2313 detects a payment instruction. The payment instruction is an instruction for designating a shift to settlement processing. The payment instruction is input by, for example, the operator touching a payment button explained below. For example, the detecting unit 2313 detects an input concerning the various operation guides displayed on the touch panel 203. In an example, the detecting unit 2313 detects an input of confirmation about a notification concerning acquisition of a privilege code. The confirmation is input by, for example, the operator touching a confirmation button explained below. In another example, the detecting unit 2313 detects an input of presence or absence of a privilege code. The presence or absence of a privilege code is input by, for example, the operator touching a “YES” button or a “NO” button explained below. In still another example, the detecting unit 2313 detects an input of mode selection. The mode selection is input by, for example, the operator touching a “POS mode” button, a “self-service mode” button, or a “maintenance” button explained below.

The determining unit 2314 determines, in response to the payment instruction being detected by the detecting unit 2313, whether information indicating acquisition of a privilege code is registered by the registering unit 2312.

The output unit 2315 outputs various operation guides. The reflecting unit 2316 validates privilege information in response to the privilege information being acquired by the acquiring unit 2311.

The settlement processing unit 2317 executes settlement processing. For example, the settlement processing unit 2317 executes the settlement processing according to selection of a payment method by the customer explained below.

The detecting unit 2313 and the output unit 2315 are explained as being implemented in the CPU 231 by executing the program but are not limited to this. The detecting unit 2313 and the output unit 2315 may be realized by the touch panel 203. The detecting unit 2313 and the output unit 2315 may be realized by cooperation of the CPU 231 and the touch panel 203 by executing the program.

Examples of screens displayed on the touch panel 203 are explained.

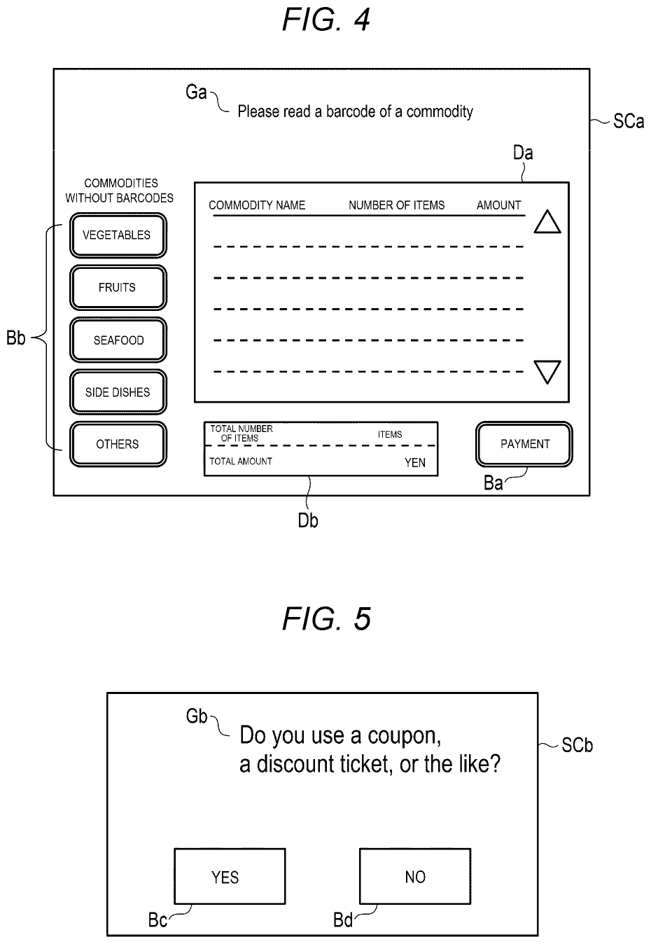

FIG. 4 is a diagram illustrating an example of a commodity registration screen displayed on the touch panel 203 of the self-service POS terminal 20 according to at least one embodiment.

As illustrated in FIG. 4, an operation guide Ga for urging the customer to perform registration operation for a commodity is displayed on a commodity registration screen SCa. A detail field Da for displaying details of registered commodities and a total field Db for displaying a total number of items and a total amount of the registered commodities are displayed on the commodity registration screen SCa. Further, category buttons Bb for the customer to designate a category of a commodity without a barcode and a “payment” button Ba for the customer to designate a shift to settlement processing are displayed on the commodity registration screen SCa. The operation guide Ga may be displayed as a moving image by using moving image data. Alternatively, the operation guide Ga may be output as voice by using voice data.

First, the customer performs registration of purchased commodities according to the commodity registration screen SCa. The customer confirms the commodity registration screen SCa and takes out the purchased commodities one by one from a basket placed on the basket table 204. If a barcode is attached to the purchased commodity, the customer holds the portion of the barcode over the reading window 2051. Then, the barcode is read by the scanner 205 and the purchased commodity is registered. Therefore, the customer puts the purchased commodity in a “my bag” or a register bag held by the bag holder 223. If a barcode is not attached to the purchased commodity, the customer touches the category button Bb corresponding to the purchased commodity. Then, a group of buttons of commodities without barcodes belonging to the category are displayed on the touch panel 203. Therefore, the customer finds a button of the purchased commodity out of the group of buttons and touches the button. In this way, the purchased commodity is registered. Therefore, the customer puts the purchased commodity in the “my bag” or the register bag held by the bag holder 223. In the purchased commodity registration, the customer can also hold a privilege code attached to a coupon, a discount ticket, or the like owned by the customer over the reading window 2051. In this case, the privilege code is read by the scanner 205 and information indicating acquisition of the privilege code is registered. If finishing registering all the purchased commodities, the customer touches the “payment” button Ba.

FIG. 5 is a diagram illustrating an example of a screen for selecting presence or absence of a privilege use displayed on the touch panel 203 of the self-service POS terminal 20 according to at least one embodiment.

As illustrated in FIG. 5, an operation guide Gb for urging the customer to perform designation operation about whether to use a privilege of a coupon, a discount ticket, or the like is displayed on a privilege use selection screen SCb. The operation guide Gb is equivalent to a notification for urging an input of presence or absence of a privilege code. A “YES” button Bc for the customer to designate use of a privilege and a “NO” button Bd for the customer to designate nonuse of a privilege are displayed. The operation guide Gb may be displayed as a moving image by using moving image data. Alternatively, the operation guide Gb may be output as voice by using voice data.

After the customer touches the “payment” button Ba, the privilege use selection screen SCb is displayed on the touch panel 203. The privilege use selection screen SCb is displayed if a privilege code is not read before the “payment” button Ba is touched. The customer confirms the privilege use selection screen SCb and, if using a privilege of a coupon, a discount ticket, or the like, touches the “YES” button Bc and, if not using a privilege, touches the “NO” button Bd.

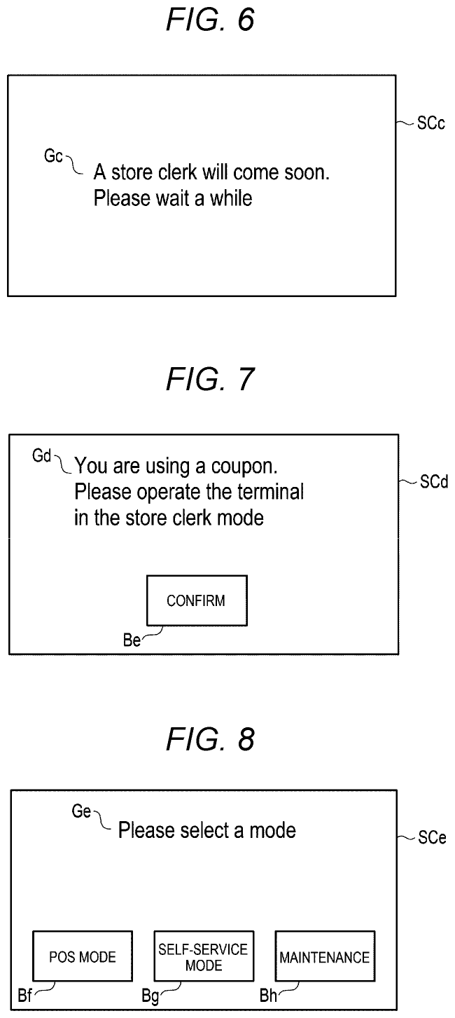

FIG. 6 is a diagram illustrating an example of a store clerk call screen displayed on the touch panel 203 of the self-service POS terminal 20 according to the embodiment.

As illustrated in FIG. 6, an operation guide Gc for informing the customer that a store clerk is called is displayed on a store clerk call screen SCc. The operation guide Gc is equivalent to a notification indicating a call of a store clerk. The operation guide Gc may include an operation guide for urging the store clerk to read a store clerk code. It is assumed that the store clerk confirms the store clerk call screen SCc and, thereafter, holds the store clerk code over the reading window 2051. Then, the store clerk code is read by the scanner 205. The operation guide Gc may be displayed as a moving image by using moving image data. Alternatively, the operation guide Gc may be output as voice by using voice data.

FIG. 7 is a diagram illustrating an example of a screen showing presence of a privilege use displayed on the touch panel 203 of the self-service POS terminal 20 according to at least one embodiment.

As illustrated in FIG. 7, an operation guide Gd for informing the store clerk that the customer uses a privilege is displayed on a privilege use confirmation screen SCd. The operation guide Gd is equivalent to a notification concerning acquisition of a privilege code. The operation guide Gd may include an operation guide for urging the store clerk to perform operation in a POS mode. A “confirmation” button Be is displayed on the privilege use confirmation screen SCd. The store clerk confirms the privilege use confirmation screen SCd and touches the “confirmation” button Be. The operation guide Gd may be displayed as a moving image by using moving image data. Alternatively, the operation guide Gd may be output as voice by using voice data.

FIG. 8 is a diagram illustrating an example of a mode selection screen displayed on the touch panel 203 of the self-service POS terminal 20 according to at least one embodiment.

As illustrated in FIG. 8, an operation guide Ge for urging the store clerk to perform selection operation for a mode is displayed on a mode selection screen SCe. A plurality of (in this embodiment, three) mode buttons Bf, Bg, and Bh are displayed on the mode selection screen SCe as selectable modes. A “POS mode” button Bf is a button for changing the mode to the POS mode. The POS mode is an operation mode for enabling operation, an authority for which is given to the store clerk. A “self-service mode” button Bg is a button for changing the mode to a self-service mode. The self-service mode is an operation mode for enabling operation by the customer. A “maintenance” button Bh is a button for changing the mode to a maintenance mode. The maintenance mode is an operation mode for enabling maintenance operation by the store clerk.

The store clerk confirms the mode selection screen SCe, selects a desired mode, and touches the mode button Bf, Bg, or Bh to which the mode is allocated. For example, the store clerk selects the “POS mode” for reading a privilege code and touches the mode button Bf. The detecting unit 2313 detects, according to a signal from the touch panel 203, that the mode button Bf, Bg, or Bh is touched. The CPU 231 changes the mode.

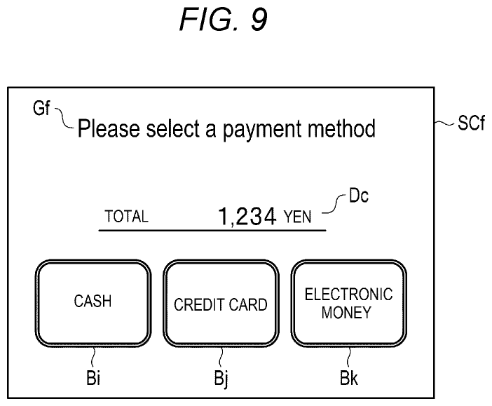

FIG. 9 is a diagram illustrating an example of a settlement screen displayed on the touch panel 203 of the self-service POS terminal 20 according to at least one embodiment.

As illustrated in FIG. 9, an operation guide Gf for urging the customer to perform payment operation is displayed on a settlement screen SCf. The settlement screen SCf is an example of settlement display. A total field Dc for displaying a total amount of purchased commodities is displayed on the settlement screen SCf. Further, a “cash” button Bi for the customer to designate payment by cash, a “credit card” button Bj for the customer to designate payment by a credit card, and an “electronic money” button Bk for the customer to designate payment by electronic money are displayed on the settlement screen SCf. The operation guide Gf may be displayed as a moving image by using moving image data. Alternatively, the operation guide Gf may be output as voice by using voice data.

The customer confirms the settlement screen SCf and selects a payment method and touches a button corresponding to the payment method according to the operation guide Gf. For example, a customer who makes payment by cash touches the “cash” button Bi and deposits cash into the bill insertion port 210 or the coin depositing port 208. Then, the self-service POS terminal 20 calculates a deposit amount and, if the deposit amount exceeds a total amount, executes settlement processing. If a change amount is calculated in the settlement processing, cash to be paid as change is dispensed from the bill dispensing port 211 or the coin dispensing port 209.

On the other hand, a customer who makes payment by a credit card touches the “credit card” button Bj and inserts the credit card from the card insertion port 206. Then, in the self-service POS terminal 20, data of the credit card is read by the card reader 238 and authentication of the credit card is performed. If the credit card is authenticated, settlement processing is executed.

A customer who makes payment by electronic money touches the “electronic money” button Bk and brings a noncontact IC card recording the electronic money close to the reader writer 213. Then, in the self-service POS terminal 20, the balance of the electronic money is read by the reader writer 213. If the balance is equal to or more than a total amount, settlement processing is executed. In the settlement processing, the balance of the electronic money is reduced by the total amount.

A procedure of purchase support processing by the self-service POS terminal 20 is explained.

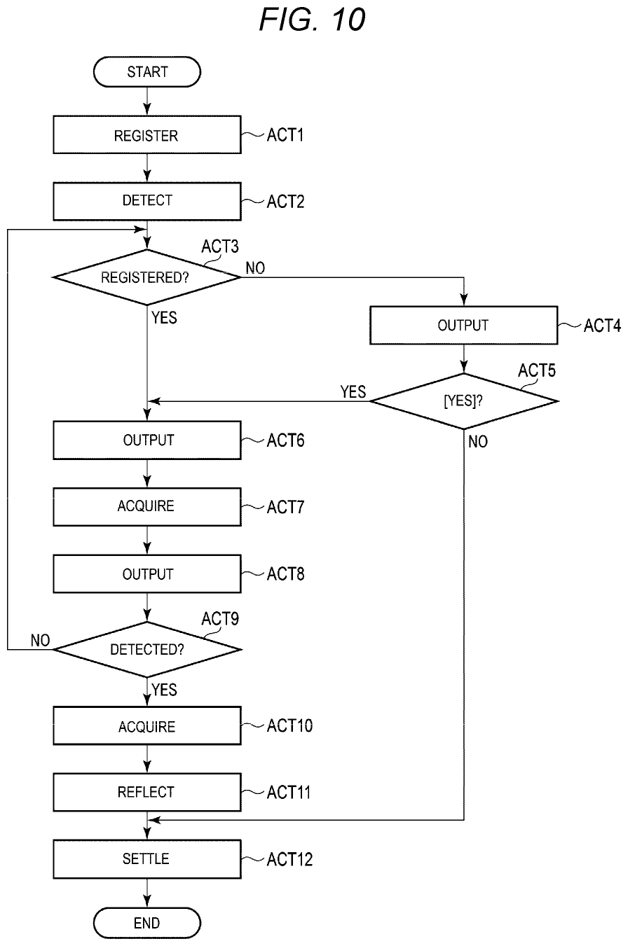

FIG. 10 is a flowchart illustrating the procedure of the purchase support processing by the self-service POS terminal 20 according to at least one embodiment.

The processing procedure explained below is only an example. Respective kinds of processing may be changed as much as possible. About the processing procedure explained below, steps may be omitted, replaced, and added as appropriate according to at least one embodiment. The operator may read customer, store clerk, or person. If not particularly described otherwise, operation in the self-service POS terminal 20 is operation in the self-service mode. An operator in the self-service mode is usually a customer but may be other operators such as a store clerk.

First, a customer coming to the payment place for payment stands in front of the self-service POS terminal 20 not in use and places a basket including purchased commodities on the basket table 204. On the other hand, a not-illustrated human sensor is provided in the self-service POS terminal 20. If the customer stands in front of the main body 200, the self-service POS terminal 20 starts purchase support processing in a procedure illustrated in the flowchart of FIG. 10. Timing for starting the purchase support processing is not limited to this. For example, a sensor for detecting that a basket is placed on the basket table 204 may be provided. If a basket is detected by the sensor, the self-service POS terminal 20 may start the purchase support processing. Alternatively, the self-service POS terminal 20 may automatically start the purchase support processing if a fixed time elapses after processing for the immediately preceding customer is finished.

If the purchase support processing is started, the commodity registration screen SCa (see FIG. 4) is displayed on the touch panel 203 by the output unit 2315. The customer performs operation according to the commodity registration screen SCa.

The registering unit 2312 registers various kinds of information based on data read by the scanner 205 (ACT 1). In ACT 1, for example, in response to a barcode of a purchased commodity being read by the scanner 205, the acquiring unit 2311 acquires the barcode of the purchased commodity read by the scanner 205. In the following explanation, “in response to” may read “based on”. The registering unit 2312 registers the purchased commodity based on the barcode of the purchased commodity acquired by the acquiring unit 2311. If a button of a commodity without a barcode is touched, the registering unit 2312 detects a signal from the touch panel 203 and registers the purchased commodity. Subsequently, the output unit 2315 displays a commodity name, the number of sold items, and a sales amount of the purchased commodity in the detail field Da of the commodity registration screen SCa. The settlement processing unit 2317 calculates a total number of items and a total amount at the present point in time based on commodity sales information stored in the auxiliary storage device 234 and displays the total number of items and the total amount in the total field Db of the commodity registration screen SCa. Since such commodity registration processing is well-known processing, explanation is omitted about details of the commodity registration processing.

In ACT 1, for example, in response to a privilege code being read by the scanner 205, the registering unit 2312 registers information indicating acquisition of the privilege code. In this example, in response to the privilege code being read by the scanner 205, the acquiring unit 2311 acquires the privilege code read by the scanner 205. In response to the acquisition of the privilege code by the acquiring unit 2311, the registering unit 2312 sets a flag indicating presence or absence of acquisition of a privilege code in the auxiliary storage device 234. That is, the registering unit 2312 sets the flag indicating presence or absence of acquisition of a privilege code to “1”. The registering unit 2312 sets the flag indicating presence or absence of acquisition of a privilege code to “1” if the privilege code is acquired before a payment instruction is input. “Before a payment instruction is input” corresponds to “during registration of the purchased commodity in the self-service mode”.

According to this example, since acquisition of a privilege code is stored, the self-service POS terminal 20 does not need to call a store clerk every time the privilege code is read. Accordingly, the self-service POS terminal 20 can reduce processing for a store clerk call. The self-service POS terminal 20 performs only processing for setting a flag without performing processing for acquiring privilege information from the privilege code. Therefore, the self-service POS terminal 20 can reduce a processing amount.

The detecting unit 2313 detects a payment instruction (ACT 2). In ACT 2, for example, the detecting unit 2313 detects a touch input of the “payment” button Ba by the customer on the commodity registration screen SCa (see FIG. 4). For example, the detecting unit 2313 detects, according to a signal from the touch panel 203, that the “payment” button Ba is touched.

In response to the payment instruction being detected by the detecting unit 2313, the determining unit 2314 determines whether information indicating the acquisition of the privilege code is registered by the registering unit 2312 (ACT 3). In ACT 3, for example, the determining unit 2314 checks a state of the flag indicating presence or absence of acquisition of a privilege code in the auxiliary storage device 234. For example, if the flag is set to “1”, the determining unit 2314 determines that the information indicating the acquisition of the privilege code is registered (YES in ACT 3). On the other hand, if the flag is set to “0”, the determining unit 2314 determines that the information indicating the acquisition of the privilege code is not registered (NO in ACT 3).

If the determining unit 2314 determines that the information indicating the acquisition of the privilege code is registered (YES in ACT 3), the processing transitions from ACT 3 to ACT 6. The determining unit 2314 determining that the information indicating the acquisition of the privilege code is registered is an example of the information indicating the acquisition of the privilege code being registered. If the determining unit 2314 determines that the information indicating the acquisition of the privilege code is not registered (NO in ACT 3), the processing transitions from ACT 3 to ACT 4. The determining unit 2314 determining that the information indicating the acquisition of the privilege code is not registered is an example of the information indicating the acquisition of the privilege code being not registered. As explained in ACT 4 and ACT 6, the output unit 2315 outputs a different notification according to the determination of presence or absence of the registration of the information indicating the acquisition by the determining unit 2314. This is an example of the output unit 2315 outputting, in response to the payment instruction being detected by the detecting unit 2313, a different notification according to presence of absence of the registration of the information indicating the acquisition.

In response to the determining unit 2314 determining that the information indicating the acquisition of the privilege code is not registered, the output unit 2315 outputs a notification for urging an input of presence or absence of a privilege code (ACT 4). In ACT 4, for example, the output unit 2315 causes the touch panel 203 to display the privilege use selection screen SCb (see FIG. 5).

The detecting unit 2313 detects an input of presence or absence of a privilege code (ACT 5). In ACT 5, for example, the detecting unit 2313 detects a touch input of the “YES” button Bc or the “NO” button Bd by the customer on the privilege use selection screen SCb. For example, the detecting unit 2313 detects, according to a signal from the touch panel 203, that the “YES” button Bc or the “NO” button Bd is touched. The customer touches the “YES” button Bc to perform an input indicating that a privilege code is used or touches the “NO” button Bd to perform an input indicating that a privilege code is not used.

According to this example, if the customer does not read a privilege code in the purchased commodity registration, the self-service POS terminal 20 can inform the customer about presence or absence of use of a privilege before performing the settlement processing. Accordingly, the self-service POS terminal 20 can prevent the customer from forgetting to use a privilege. Since a privilege code can be applied before the settlement processing is performed, the self-service POS terminal 20 can simplify the settlement processing compared with when the privilege code is applied after the settlement processing.

If the detecting unit 2313 detects the touch input of the “YES” button Bc (YES in ACT 5), the processing transitions from ACT 5 to ACT 6. The touch input of the “YES” button Bc being detected by the detecting unit 2313 is an example of the “YES” button Bc being touch-input. If the detecting unit 2313 detects the touch input of the “NO” button Bd (NO in ACT 5), the processing transitions from ACT 5 to ACT 12. The touch input of the “NO” button Bd being detected by detecting unit 2313 is an example of the “NO” button Bd being touch-input.

The output unit 2315 outputs a notification indicating a call for a store clerk (ACT 6). In ACT 6, in an example, the output unit 2315 outputs, in response to the determining unit 2314 determining that the information indicating the acquisition of the privilege code is registered, the notification indicating a call for a store clerk. In another example, the output unit 2315 outputs, in response to a touch input of the “YES” button Bc by the customer on the privilege use selection screen SCb being detected by the detecting unit 2313, the notification indicating a call for a store clerk. For example, the output unit 2315 causes the touch panel 203 to display the store clerk call screen SCc (see FIG. 6). The output unit 2315 may cause the light emitting unit 2021 of the display pole 202 to emit light and notify the call to a store clerk. The store clerk receiving the call confirms the store clerk call screen SCc and holds a store clerk code over the reading window 2051. The store clerk code is read by the scanner 205.

According to this example, the self-service POS terminal 20 performs the store clerk call after receiving the payment instruction. Therefore, even if a privilege code is read a plurality of times, the store clerk call is performed once. Accordingly, the self-service POS terminal 20 can reduce a burden on the store. The self-service POS terminal 20 can reduce processing for the store clerk call.

The acquiring unit 2311 acquires store clerk information based on an acquired store clerk code (ACT 7). In ACT 7, for example, the acquiring unit 2311 acquires a store clerk code read by the scanner 205 after the notification indicating a call for a store clerk is output by the output unit 2315. The acquiring unit 2311 acquires, based on the acquired store clerk code, store clerk information correlated with the store clerk code from the auxiliary storage device 234.

The output unit 2315 outputs a notification concerning acquisition of privilege information in response to the store clerk information being acquired by the acquiring unit 2311 (ACT 8). The store clerk information being acquired by acquiring unit 2311 is an example of the store clerk code being acquired by the acquiring unit 2311. In ACT 8, for example, the output unit 2315 causes the touch panel 203 to display the privilege use confirmation screen SCd (see FIG. 7). In ACT 8, for example, the detecting unit 2313 detects a touch input of the “confirmation” button Be by the store clerk on the privilege use confirmation screen SCd. For example, the detecting unit 2313 detects, according to a signal from the touch panel 203, that the “confirmation” button Be is selected. In ACT 8, the CPU 231 changes the operation mode to an attendant mode in response to the touch input of the “confirmation” button Be being detected by the detecting unit 2313. The attendant mode is an operation mode for enabling a store clerk to switch the operation mode. The registering unit 2312 resets, in response to the touch input of the “confirmation” button Be being detected by the detecting unit 2313, the flag indicating presence or absence of acquisition of a privilege code to “0” in the auxiliary storage device 234.

The detecting unit 2313 detects a mode selection instruction (ACT 9). In ACT 9, for example, the output unit 2315 outputs a mode selection screen in response to an input of confirmation about a notification concerning acquisition of privilege information being detected by the detecting unit 2313. For example, the output unit 2315 causes the touch panel 203 to display the mode selection screen SCe (see FIG. 8). In ACT 9, for example, the detecting unit 2313 detects a touch input of the mode buttons Bf, Bg, or Bh by the store clerk on the mode selection screen SCe. In this example, the store clerk touches the “POS mode” button Bf in order to read a privilege code. The detecting unit 2313 detects, according to a signal from the touch panel 203, that the “POS mode” button Bf is touched. The CPU 231 changes the operation mode to the POS mode in response to the touch input of the “POS mode” button Bf being detected by the detecting unit 2313.

If the CPU 231 changes the operation mode to the POS mode (YES in ACT 9), the processing transitions from ACT 9 to ACT 10. If the CPU 231 does not change the operation mode to the POS mode (NO in ACT 9), the processing transitions from ACT 9 to ACT 3.

The acquiring unit 2311 acquires privilege information (ACT 10). In ACT 10, for example, the acquiring unit 2311 acquires privilege information based on a privilege code acquired after the detecting unit 2313 detects the mode selection instruction on the mode selection screen. In this example, the acquiring unit 2311 acquires a privilege code read by the scanner 205 after the CPU 231 changes the operation mode to the POS mode. “After the CPU 231 changes the operation mode to the POS mode” is an example of “after the detecting unit 2313 detects the touch input of the “POS mode” button Bf on the mode selection screen SCe. “After the CPU 231 changes the operation mode to the POS mode” is an example of “after the detecting unit 2313 detects a touch input of the “confirmation” button Be about the operation guide Gd”. The acquiring unit 2311 acquires, based on the privilege code, privilege information correlated with the privilege code from the auxiliary storage device 234. The acquiring unit 2311 acquires the privilege information only if the privilege code is acquired in the POS mode.

According to this example, the self-service POS terminal 20 acquires privilege information only in the POS mode and does not acquire privilege information in the self-service mode. Accordingly, the self-service POS terminal 20 can prevent an unauthorized use of a privilege.

In response to the privilege information being acquired by the acquiring unit 2311, the reflecting unit 2316 validates the privilege information (ACT 11). In ACT 11, for example, the reflecting unit 2316 reflects the privilege information on the total amount of the purchased commodities (e.g., performs processing to take into account the privilege information, so as to apply it to the total amount of purchased commodities). In an example, the reflecting unit 2316 reflects, on the total amount of the purchased commodities, a price-cut amount or a discount rate indicated by the privilege information. In another example, the reflecting unit 2316 reflects, on the total amount of the purchased commodities, point granting conforming to a point granting ratio indicated by the privilege information. Point granting processing is well-known processing. Therefore, an explanation is omitted regarding details of the point granting processing.

If the privilege information acquired by the acquiring unit 2311 is invalid, the reflecting unit 2316 does not reflect the privilege information on the total amount of the purchased commodities. The invalidity of the privilege information includes expiration, a date excluded from application target dates, and a commodity excluded from application target commodities. In this case, the output unit 2315 may output an invalidity notification indicating that a privilege is invalid. For example, if the store clerk confirms the notification indicating that the privilege is invalid, the mode is switched to the self-service mode. The processing transitions to ACT 3.

The settlement processing unit 2317 executes settlement processing (ACT 12). In ACT 12, for example, the output unit 2315 causes the touch panel 203 to display the settlement screen SCf (see FIG. 9). The output unit 2315 displays an amount reflecting the privilege information in the total field Dc of the settlement screen SCf. If the detecting unit 2313 detects, according to a signal from the touch panel 203, that the “cash” button Bi is touched, the settlement processing unit 2317 executes settlement processing by cash payment. Similarly, if the detecting unit 2313 detects that the “credit card” button Bj is touched, the settlement processing unit 2317 executes settlement processing by credit card payment. If the detecting unit 2313 detects that the “electronic money” button Bk is touched, the settlement processing unit 2317 executes settlement processing by electronic money. In the settlement processing, settlement information including a total amount, a payment method, and a payment amount is stored in the auxiliary storage device 234. Since such settlement processing is well-known processing, explanation is omitted about details of the settlement processing.

If the settlement processing unit 2317 ends the settlement processing, the output unit 2315 causes the touch panel 203 to display a settlement end screen (not illustrated).

If the information indicating the acquisition of the privilege code is not registered in ACT 3 (NO in ACT 3), the processing may transition to ACT 12 skipping ACT 4 and ACT 5.

In the embodiment explained above, the privilege code is explained as being a code attached to a coupon, a discount ticket, or the like but is not limited to this. The privilege code may include any code applied to the settlement processing.

In the embodiment, the registering unit 2312 is explained as setting the flag indicating presence or absence of acquisition of a privilege code in response to the acquisition of the privilege code by the acquiring unit 2311 but is not limited to this. For example, the registering unit 2312 may set a flag according to whether the privilege code is valid. In this case, if the privilege code is valid, the registering unit 2312 sets the flag to “1”. If the privilege code is invalid, the output unit 2315 may output an invalidity notification. According to this example, the self-service POS terminal 20 can set the flag only if a valid privilege code is acquired. Accordingly, the self-service POS terminal 20 does not need to call a store clerk if the acquired privilege code is invalid. Accordingly, the self-service POS terminal 20 can reduce processing for a store clerk call.

In at least one embodiment, the self-service POS terminal 20 is illustrated. However, a POS terminal with which a store clerk performs operation from registration to settlement of purchased commodities may be capable of realizing at least a part of the functions of the self-service POS terminal 20 in this embodiment. A so-called semi-self-service settlement apparatus (payment apparatus) with which a store clerk performs registration of purchased commodities and a customer performs settlement of the purchased commodities may be capable of realizing at least a part of the functions of the self-service POS terminal 20 in at least one embodiment. Further, a so-called cart POS terminal in which a commodity scanner and a dedicated terminal operated by a customer are attached to a cart or a smartphone POS terminal in which commodity registration is performed by a terminal such as a tablet terminal or a smartphone may be capable of realizing at least a part of the functions of the self-service POS terminal 20 in at least one embodiment.

The purchase support apparatus may be realized by one apparatus as explained using the self-service POS terminal 20 as an example or may be realized by a system in which functions are distributed to a plurality of apparatuses.

In general, transfer of the purchase support apparatus is performed in a state in which a program is stored in a main memory or an auxiliary storage device. However, not only this, but the purchase support apparatus may be transferred in a state in which the program is not stored in the main memory or the auxiliary storage device. In this case, the program transferred separately from the purchase support apparatus is written in a writable storage device included in the purchase support apparatus according to operation by a user or the like. The transfer of the program can be performed by being recorded in a removable recording medium or by communication via a network. A form of the recording medium may be any form if the recording medium can store the program and can be read by an apparatus like a CD-ROM or a memory card. A function obtained by installation or download of the program may be a function realized by cooperation with an OS (operating system) or the like inside the apparatus.

Several embodiments are explained above. However, these embodiments are presented as examples and are not intended to limit the scope of the disclosure. These new embodiments can be implemented in other various forms. Various omissions, substitutions, and changes can be made without departing from the spirit of the disclosure. These embodiments and modifications of the embodiments are included in the scope and the gist of the disclosure and included in the disclosure described in claims and the scope of equivalents of the disclosure.

What is claimed is:

1. A purchase support apparatus comprising:
at least one processor configured to:
register information indicating acquisition of a privilege code;
detect a payment instruction;
output, in response to the payment instruction being detected by the at least one processor, a different notification according to presence or absence of the registration of the information indicating the acquisition.

2. The apparatus according to claim 1, wherein the at least one processor is configured to, in response to the information indicating the acquisition being registered, output a notification indicating a call for a store clerk.

3. The apparatus according to claim 2, the at least one processor further configured to acquire a store clerk code after the notification indicating the call for the store clerk is output, wherein
the at least one processor is configured to output, in response to the store clerk code being acquired by the at least one processor, a notification concerning acquisition of a privilege code.

4. The apparatus according to claim 3, wherein
the at least one processor is configured to detect an input of confirmation about the notification concerning the acquisition of the privilege code,
the at least one processor is configured to acquire privilege information based on the privilege code acquired after the at least one processor detects the input of the confirmation, and
the at least one processor is configured to validate the privilege information in response to the privilege information being acquired by the at least one processor.

5. The apparatus according to claim 1, wherein the apparatus includes a self-service point of sale terminal.

6. The apparatus according to claim 1, wherein the privilege code is attached to a coupon or a discount ticket.

7. The apparatus according to claim 1, further comprising a reader configured to read a bar code to identify a store commodity.

8. The apparatus according to claim 7, wherein the reader is configured to read the privilege code.

9. The apparatus according to claim 1, wherein the at least one processor is configured to acquire store clerk information correlating with a read store clerk code.

10. The apparatus according to claim 1, further comprising a display configured to display information from the at least one processor.

11. The apparatus according to claim 10, wherein the display includes a touch panel.

12. The apparatus according to claim 11, wherein the touch panel is configured to receive input of an operator.

13. The apparatus according to claim 11, wherein the at least one processor is configured to execute settlement processing according to selection of an input to the touch panel by an operator.

14. A purchase support method comprising:
registering information indicating acquisition of a privilege code;
detecting a payment instruction; and
outputting, in response to the payment instruction being detected, a different notification according to presence or absence of the registration of the information indicating the acquisition.

15. The method according to claim 14, further comprising outputting a notification indicating a call for a store clerk in response to the information indicating the acquisition being registered.

16. The method according to claim 15, further comprising:
acquiring a store clerk code after the notification indicating the call for the store clerk is output; and
outputting, in response to the store clerk code being acquired, a notification concerning acquisition of a privilege code.

17. The method according to claim 16, further comprising:
detecting an input of confirmation about the notification concerning the acquisition of the privilege code;
acquiring privilege information based on the privilege code acquired after the input of the confirmation; and
validating the privilege information in response to the privilege information being acquired by the at least one processor.
